(19) United States
(12) Patent Application Publication
(10) Pub. No.: US 2005/0149971 A1
(43) Pub. Date: Jul. 7, 2005

(54) Interactive television hot key manager

(76) Inventor: Bryan Severt Hallberg, Vancouver, WA (US)

Correspondence Address: MARGER JOHNSON & MCCOLLOM, P.C. - SHARP, 1030 SW MORRISON STREET, PORTLAND, OR, 97205, US

(21) Appl. No.: 10/977,213

(22) Filed: Oct. 29, 2004

Related U.S. Application Data
(60) Provisional application No. 60/535,048, filed on Jan. 6, 2004.

(51) Int. Cl. G06F 3/00; H04N 5/445; G06F 13/00

(52) U.S. Cl. 725/52; 725/61; 725/60

(57) ABSTRACT

The invention relates to an improved interactive television having a hot key manager. The hot key manager allows simple programming of hot keys on a television remote control that when actuated, accesses a viewer's favorite channels, applications, and/or functions.

This application claims priority from U.S. Provisional Application No. 60/535,048 filed Jan. 6, 2004, which we incorporate by reference.

### FIELD

This invention relates generally to a television and, more particularly, to an improved television having an interactive hot key manager.

### BACKGROUND

Interactive televisions often include a wide variety of applications, in turn, containing a large selection of available viewer functions. Different viewers have different use patterns, with each viewer having favorite applications or application functions.

Existing televisions use dedicated remote control buttons for the functions accessed by most viewers, e.g., volume controls. Dedicated buttons suffer from inflexibility in that they are preset at the factory and do not allow the viewer to change the dedicated buttons to meet their use patterns.

Other existing televisions use setup menus to program desired quick access features. Setup menus can be complex and cumbersome, such that the viewer does not often use the quick access feature. Even other existing televisions allow viewers to program a button on a remote control to perform the identical function on another remote control, but not a function currently existing on neither remote.

Accordingly, a need remains for an improved television that allows a viewer to quickly access and program favorite applications and functions into their remote control buttons.

### BRIEF DRAWING DESCRIPTION

The foregoing and other objects, features, and advantages of the invention will become more readily apparent from the detailed description of invention embodiments that references the following drawings.

FIG. 1 is a block diagram of a television embodiment.

FIG. 2 is a diagram of a remote control's hot keys.

FIG. 3 is a block diagram of a hot key assignment interface.

FIG. 4 is a flow diagram of a method for using an interactive television hot key manager.

### DETAILED DESCRIPTION

For convenience, like numerals in the description refer to like structures in the drawings. The invention we describe here may provide a system and method to use assignable hot keys to simplify television controls.

Hot keys provide efficient and convenient television control, particularly if the hot keys are easy to program and use. For example, hot key buttons allow viewers to easily program interactive televisions so that a single hot key button press activates the desired application or function within the application or selects a channel. The invention is discussed herein as being primarily related to televisions and remote controls, although it is not limited to these traditional objects. Hot key manager embodiments are explained in detail below to provide examples of how to make and use the present invention.

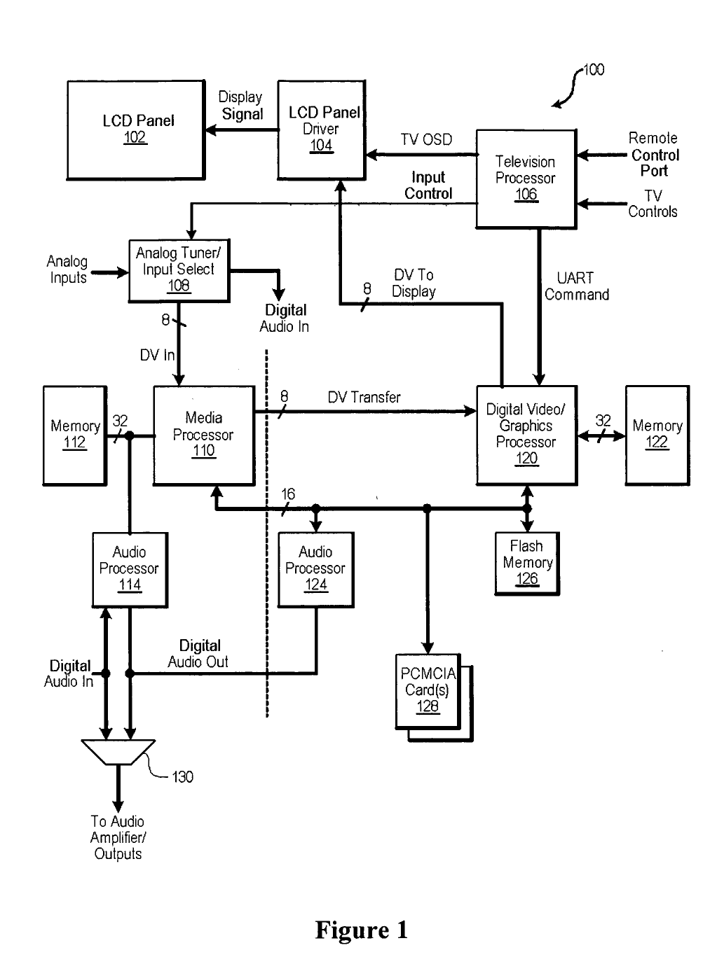

FIG. 1 is a block diagram of a television system embodiment that implements the hot key manager. The hot key manager that programs, displays, and otherwise manages hot keys may be implemented in one or a plurality of the blocks shown in FIG. 1. Referring to FIG. 1, the television 100 includes a display panel 102 having a fixed pixel structure, e.g., a liquid crystal display (LCD), plasma display, and the like. For simplicity, the present embodiment refers to panel 102 as an LCD panel (or display). Television 100 contains an LCD panel 102 to display visual output to a viewer based on a display signal generated by an LCD panel driver 104. LCD panel driver 104 accepts a primary digital video signal in CCIR656 format (eight bits per pixel YCbCr, in a “4:2:2” data ratio wherein two Cb and two Cr pixels are supplied for every four luminance pixels) from a digital video/graphics processor 120. A person of reasonable skill in the art should recognize that the LCD panel driver 104 may accept a primary digital video signal in formats other than CCIR656 and still come within the scope of the present invention.

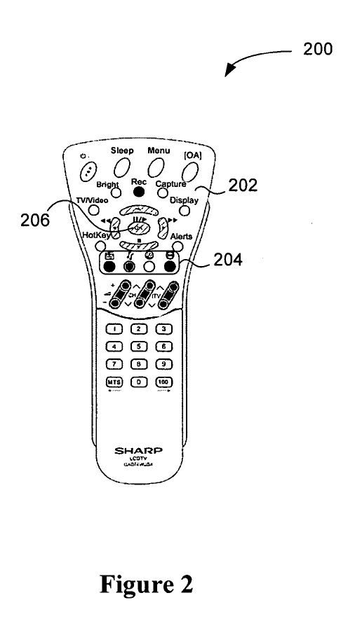

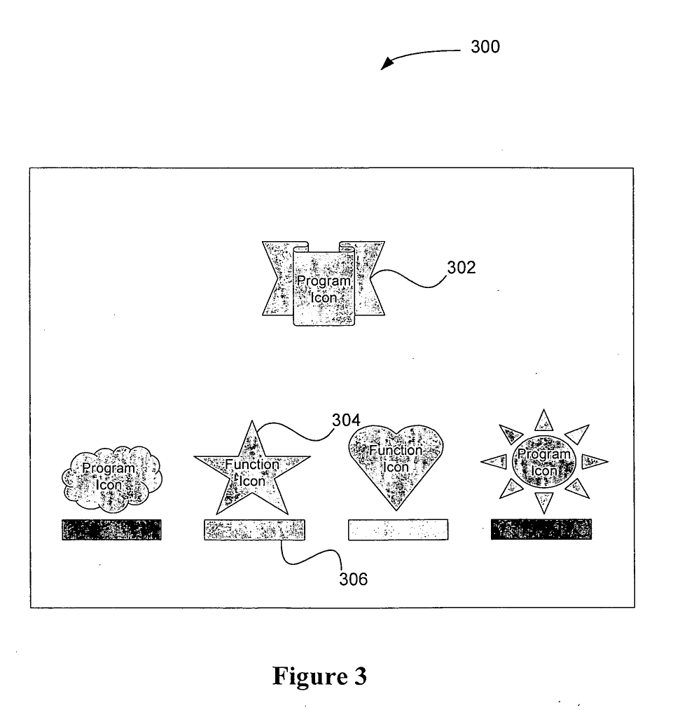

A television processor 106 provides basic control functions and viewer input interfaces for television 100. Television processor 106 receives viewer commands, both from buttons located on the television itself (TV controls) and from a handheld remote control (FIGS. 2-3) through the Remote Control Port. The Remote Control Port may accept input from the remote control in a variety of manners including infrared and radio waves as are well known in the art.

Based on the viewer's commands, television processor 106 controls an analog tuner/input select section 108, and also supplies viewer inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or Red Green Blue (RGB) component video inputs, although various embodiments may not accept each of these signal types or may accept signals in other formats (such as PAL). The selected video input is converted to a digital data stream, DV In, in CCIR656 format (or other formats) and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 may function as a master processor and media processor 110 may function as a slave processor. Media processor 110 supplies digital video, either corresponding to DV In or to a decoded media stream from another source, to digital video/graphics processor 120 over a DV transfer bus.

Media processor 110 performs coding and decoding of digital media streams for television 100, as instructed by digital video/graphics processor 120. In an embodiment, the media processor 110 performs MPEG (Motion Picture Expert Group) coding and decoding. A person of reasonable skill in the art should recognize that media processor 110 may code and decode various other digital formats. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100, including the hot key manager described in more detail below. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code such as may be necessary to implement aspects of the hot key manager, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

An embodiment of a remote control 200 is shown in FIG. 2. The embodiment includes a set of buttons 204, called hot keys, on a television remote control 200, as well as a standard set of buttons 202 on the remote control 200. The standard buttons 202 allow a user to select any from a plurality of viewer inputs to the television 100. A hot key 204 may be configured as any of the plurality of viewer inputs. A person of skill in the art should recognize that the present invention applies to a remote control 200 for any display, for example, one capable of displaying broadcast or any other displayable signals, including known televisions. A person of skill in the art should also recognize that hot keys 204 may exist on a television 100 itself or on any other device that may communicate with or control a television 100. For example, the hot key 204 may input into television processor 106 through the remote control port or the television controls, as show in television 100 in FIG. 1. In some embodiments, the hot key buttons 204 are preset at the factory with the features preferred by most viewers. Presetting allows viewers out of the box access to preferred applications and functions.

The present invention allows a viewer to easily program hot keys 204 for control of a television 100. Doing so allows the viewer quick access to desired television channels, applications, or application functions. Furthermore, different viewers can use the hot keys 204 for different functions.

The embodiment in FIG. 2 is shown with different colored hot keys 204. In some embodiments, the hot key 204 buttons may be a color different than other buttons 202 on the remote control 200 for easy identification and use. For example, there may be four hot key 204 buttons (red, green, blue, and yellow) and any number of regular remote control 200 buttons 202 (all grey or black). In another embodiment, the hot key 204 buttons may have different shapes or textures. In yet another embodiment, the hot key 204 buttons may have different text or icons appearing on or next to the hot key 204 buttons.

There are many ways to program hot keys 204. An exemplary method has a viewer first navigating to a location on the television display, for example LCD panel 102, where an application or application function would normally be activated if the viewer actuated a preset activation key. The viewer then programs a hot key 204 by actuating or pressing a hot key program button 204. In FIG. 2, a hot key program button is shown as a hot key 204. Some embodiments may have a separate hot key program button 204. The hot key program button 204 may be, e.g., a set, program, memory, or program hot key button, or any input that assigns a hot key 204 to a currently focused channel, application, or application function. The hot key program button 204 may be any key that is actuated by depressing beyond a given duration. The two-step procedure assigns the currently focused channel, application or application function to the hot key 204. Furthermore, the programming and activating of hot keys 204 may be similar such that a viewer is not required to learn different procedures for each task.

In an embodiment, a hot key 204 has only one function assigned to it at any one time. Some embodiments allow a single function to be assigned to multiple hot keys 204.

On interactive televisions, there are often operations that may be activated by a remote control 200 button press. For example, the television 100 may have a plurality of applications typically activated by using the remote control 200 to navigate a cursor to an icon or to text representing the application using navigational keys. Once the cursor is positioned on the icon representing the desired application, the viewer activates the application by pressing a preset activation key or button, e.g., “Enter” or “OK” 206. In an embodiment a hot key 204 may be configured as the Enter or OK input. In some embodiments, the hot key 204 may be configured as the application that is navigated to and selected by the Enter, OK or other button 202.

Further, each application may have individual functions. The viewer activates the functions also by an activation key press. For example, the viewer may navigate through an application until the cursor highlights the desired function, and then activate the currently highlighted function by pressing the appropriate preset activation key, e.g., “OK”. In an embodiment a hot key 204 may be configured as the Enter or OK input. In some embodiments, the hot key 204 may be configured as the application that is navigated to and selected by the Enter, OK or other button 202.

In an embodiment, the television 100 continues to display content, applications or functions while it displays hot key graphics indicative of hot key assignments through a graphical user interface (GUT) 300 as shown, e.g., in FIG. 3. In an embodiment, the television may accomplish this overlaying using well known on screen display technology. In an embodiment, any of the broadcast content, the application or the application function may be dimmed to accentuate the hot key graphics.

In an embodiment, a hot key GUI 300 may comprise a previously focused icon or text plus graphics representing current hot key button assignments as shown in FIG. 3. The GUI 300 may be displayed on the LCD panel 102 of television 100. Referring to the GUI 300 in FIG. 3, each currently assigned hot key button assignment is indicated, e.g., with a colored bar 306 under each hot key button icon 304. The colored bar 306 indicates or represents the associated application or function.

An embodiment may display or program current hot key 204 assignments with a simple two-step procedure. Examples of the two-step procedure include pressing a button and holding it depressed, pressing a sequence of buttons, or installing a view assignments button followed by a viewer pressing the view assignments button to view the current hot key 204 assignments. For example, the two-step display procedure may activate a GUI 300 to display the current hot key 204 assignments.

After pressing the desired hot key 204, the hot key graphics 302 or 304 may be replaced with the application or function associated with the hot key 204 whether it was a broadcast channel or any other application or function on the television. For example, if the television was displaying a program 302 broadcast over a particular channel (and not an application or function) when the hot key program button was actuated, the channel would be associated with the hot key 204 the viewer selected. This association allows the viewer subsequently to access the channel with a single hot key 204 press.

In an embodiment, if the application or function does not support hot key programming, the television 100 could overlay a message so stating, e.g., “Function Does Not Support Hot Key Programming.”

In an embodiment, hot key assignments may be stored in non-volatile memory, for example Flash 126 or any other associated memory capable of being non-volatile, such that assignments are preserved even when the television 100 cycles on and off. That is, hot key assignments survive even after power to the television 100 is off.

In an embodiment, if a viewer actuates a hot key 204 but the associated application or function is not currently running, the television 100 may launch the application and/or activate the function associated with the actuated hot key 204.

It should be clear to a person of reasonable skill in the art that the invention may support hot key button programming of applications and functions incrementally added to interactive televisions over time.

In an embodiment, the television 100 assigns a value to each function or input capable of being programmed on a hot key 204. When a hot key 204 is programmed, the television 100 stores the path to the application and the value representing the function or input in non-volatile memory. When the hot key 204 is activated, the television sends a message to the application requesting that the application activate the function or input of the assigned value. Each application should assign only one function or input to a single value. Multiple applications can use the same value, as the television only sends the activation command to the application or input to which the hot key 204 was assigned. In an embodiment, the value is an integer value.

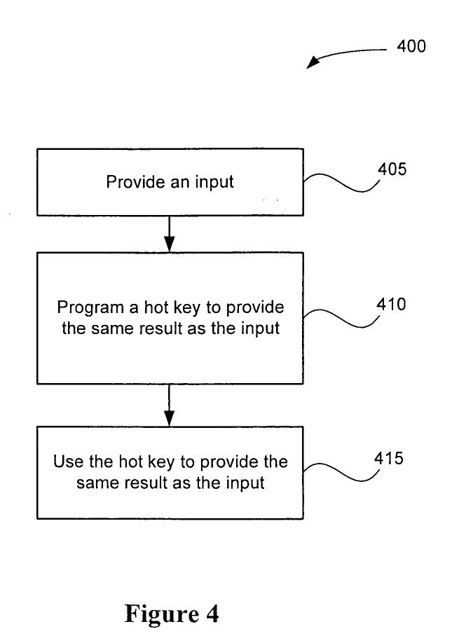

FIG. 4 is a flow diagram of a method of using a hot key manager 400 to access desired television channels, applications, or application functions quickly. An input is provided at box 405 to the television 100. In an embodiment, an input is provided to the television 100 from a remote control while other embodiments provide for receiving the input from a television control. The input may be any of a channel selection, an application selection, an application program selection, or any other television input capable of being accessed by a hot key. In box 410, a hot key is programmed to provide the result of the input from box 405. The hot key may be programmed in a simple two-step process. The hot key may be selected from a plurality of hot keys; each of the plurality may be programmed and used with the hot key manager interface as described in relation to FIG. 3. In block 415, the viewer actuates the hot key to provide the same result as the input signal. That is, the viewer actuates the (programmed) hot key to access the desired input.

Although the invention has been described with reference to certain specific embodiments, various modifications thereof will be apparent to those skilled in the art without departing from the spirit and scope of the invention as outlined in the appended claims.

1. An apparatus comprising:
a television processor to respond to a plurality of viewer inputs;
a memory to store key settings; and
a hot key in communication with the television processor and the memory, the hot key configurable as any of the plurality of viewer inputs.

2. The apparatus of claim 1 wherein each of the plurality of viewer inputs is an application selection, an application function selection or a channel selection.

3. The apparatus of claim 1 further comprising a set button, the set button to be used in conjunction with the hot key to assign the hot key to any of the plurality of viewer inputs in a two-step procedure.

4. The apparatus of claim 3 wherein the hot key is the set button.

5. The apparatus of claim 1 further comprising a display to show hot key assignments.

6. The apparatus of claim 5 wherein any hot key out of a plurality of hot keys can be assigned to any of the plurality of viewer inputs.

7. The apparatus of claim 5 wherein the display provides a graphical user interface for hot key assignments.

8. The apparatus of claim 6 wherein the viewer inputs are associated with a value, the value also associated with a hot key.

9. The apparatus of claim 1 wherein the memory is non-volatile memory, the memory to store a hot key assignment through at least one power cycle.

10. A system comprising:
a display to respond to a plurality of viewer inputs;
a memory to store key settings; and
a remote control, the remote control further comprising a hot key, the hot key configurable as any of the plurality of viewer inputs.

11. The system of claim 10 wherein each of the plurality of viewer inputs is an application selection, an application function selection or a channel selection.

12. The system of claim 10 further comprising a set button, the set button to be used in conjunction with the hot key to assign the hot key to any of the plurality of viewer inputs.

13. The system of claim 12 wherein the set button can be used in conjunction with the hot key to assign the hot key to any of the plurality of viewer inputs in a two-step procedure.

14. The system of claim 13 wherein the hot key is the set button.

15. The system of claim 10 wherein the display can provide a graphical user interface for hot key assignments.

16. The system of claim 15 wherein the display overlays the display of key assignments onto regular display content.

17. The system of claim 15 wherein any hot key out of a plurality of hot keys can be assigned to any of the plurality of viewer inputs.

18. The system of claim 10 wherein the memory is non-volatile memory, the memory to store a hot key assignment through at least one power cycle.

19. The system of claim 10 wherein the display is a television.

20. A method comprising:
providing an input to a display device;
programming a hot key to provide the same result as the input to the display device; and
using the hot key to provide the same result as the input to the display device.

21. The method of claim 20 wherein the input is an application selection, an application function selection or a channel selection.

22. The method of claim 20 further comprising, displaying a hot key and what input the hot key is programmed to provide.

23. The method of claim 20 further comprising, selecting any hot key out of a plurality of hot keys and assigning the hot key to an input.

24. The method of claim 20 further comprising, storing the hot key and an associated input in non-volatile memory so the hot key will remain programmed after a power cycle.
